(19) United States
(12) Patent Application Publication
(10) Pub. No.: US 2004/0140401 A1
(43) Pub. Date: Jul. 22, 2004

(54) System and method for controlling the attitude of a flying object

(75) Inventor: Toshiaki Yamashita, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/650,845

(22) Filed: Aug. 29, 2003

(30) Foreign Application Priority Data
Aug. 30, 2002 (JP) 2002-255450

(51) Int. Cl. B64G 1/28

(52) U.S. Cl. 244/165

(57) ABSTRACT

The attitude of a satellite is controlled by at least three reaction wheels having mutually different rotation axes and at least two control moment gyroscopes having gimbal axes which extend in an equal direction. The reaction wheels and the control momentum gyros are controlled according to calculated values. When the rotors of the gyroscopes are given rotations in opposite directions to each other, angular momentum vectors are produced in respective directions normal to the directions of rotation of the rotors about their gimbal axes.

### BACKGROUND OF THE INVENTION

1. Field of the Invention

The present invention relates generally to positioning of a flying object such as spacecraft, and more particularly to attitude control of the flying object.

2. Description of the Related Art

Japanese Patent No. 1,976,960 discloses a 3-axis attitude control system for controlling the attitude of a satellite. The prior art system comprises two gimbals and a momentum wheel for producing torque for spacecraft dynamics. While the prior art attitude control system is capable of generating large control torque by the use of two gimbals for X- and Y-axis correction in comparison with the conventional momentum wheel that is used for Z-axis correction, the control resolution of angular velocity of the gimbals is constrained and hence precision attitude control is impossible. Furthermore, when the rotor of one gimbal is given rotation about its gimbal axis to generate torque about the associated axis, this rotation causes the angular momentum vector to change its direction and control torque also changes its direction. The same applies to the other gimbal when its rotor is given rotation about its gimbal axis. Therefore, it is difficult to continuously generate control torque about both X-axis and Y-axis.

### SUMMARY OF THE INVENTION

It is therefore an object of the present invention to provide a system and method for controlling the attitude of a flying object with high resolution by producing accurate torque in quick response to a command signal.

According to a first aspect of the present invention, there is provided a system for controlling the attitude of a flying object, comprising at least three reaction wheels having mutually different rotation axes, means for controlling rotation of the reaction wheels for controlling the attitude of the flying object, at least two control moment gyroscopes having gimbal axes which extend in an equal direction, the gyroscopes including respective rotors, and means for controlling rotation of the rotors in opposite directions to each other for controlling the attitude of the flying object so that angular momentum vectors of the rotors are produced in respective directions normal to the directions of rotation of the rotors about the respective gimbal axes.

According to a second aspect, the present invention provides a method of controlling the attitude of a flying object, comprising producing torque by controlling rotation of at least three reaction wheels whose rotation axes are mutually different from each other, and controlling rotation of respective rotors of at least two control moment gyroscopes whose gimbal axes extend in an equal direction, the rotation being such that the rotors are rotated in opposite directions to each other so that angular momentum vectors of the rotors are produced in respective directions normal to the directions of rotation of the rotors about the respective gimbal axes.

### BRIEF DESCRIPTION OF THE DRAWINGS

The present invention will be described in detail further with reference to the following drawings, in which:

FIG. 1 is a block diagram of an attitude control system of a first embodiment of the present invention,

FIG. 2 is a block diagram of the attitude correction profile calculator of FIG. 1;

FIG. 3 is a perspective view of a reaction wheel (RW) system of the present invention;

FIG. 4 is a perspective view of a control moment gyroscope (CMG) system of the present invention;

FIG. 5 is a flowchart of the operation of the attitude correction profile calculator of FIG. 2;

FIG. 6A is a graphic representation of the attitude angle of a flying object plotted as a function of time;

FIG. 6B is a graphic representation of the angular velocity of the flying object plotted as a function of time;

FIG. 6C is a graphic representation of the angular acceleration of the flying object plotted as a function of time;

FIG. 7 is a perspective view of a reaction wheel (RW) system of a modified embodiment of the present invention;

FIG. 8 is a block diagram of an attitude control system of a second embodiment of the present invention;

FIG. 9 is a block diagram of the attitude correction command generator of FIG. 8;

FIG. 10 is a flowchart of the operation of the attitude correction command generator of FIG. 9;

FIG. 11 is a block diagram of a prior art attitude control system; and

FIG. 12 is a perspective view of the prior art attitude control system.

### DETAILED DESCRIPTION

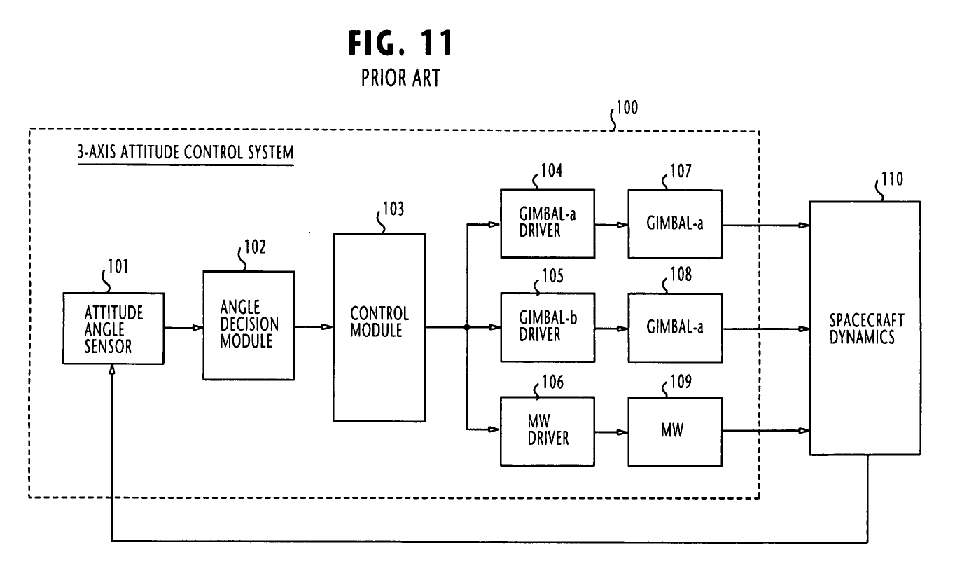

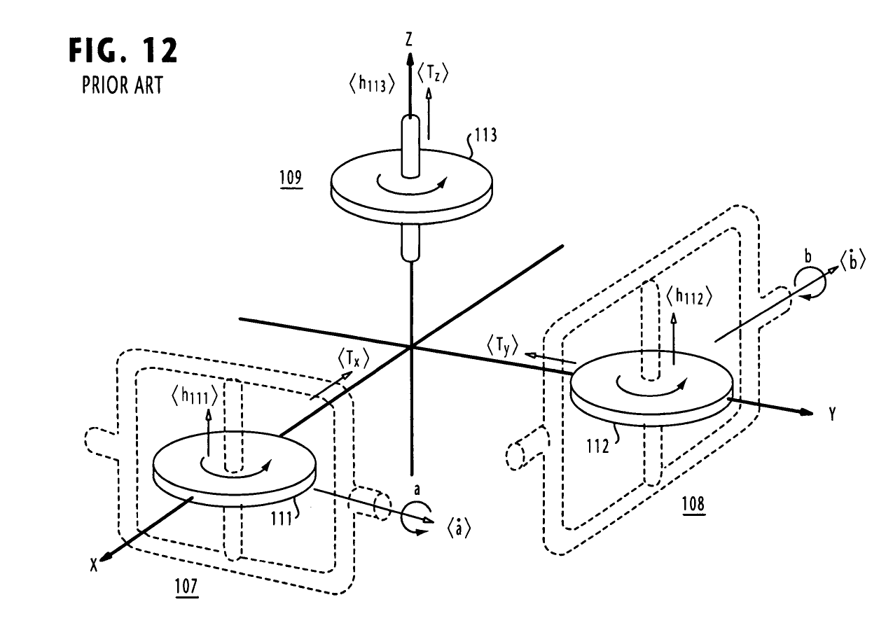

Before proceeding with the detailed description of the present invention, it may prove helpful to provide an explanation of the prior art with reference to FIGS. 11 and 12. The 3-axis attitude control system of the prior art Japanese Patent No. 1,976,960) is illustrated in FIG. 11. The system 100 includes an attitude angle sensor 101, an attitude decision module 102, and a control module 103. A gimbal-a driver 104, a gimbal-b driver 105 and a MW (momentum wheel) driver 106 are provided to receive control signals from the control module 103 in order to drive a gimbal-a 107, a gimbal-b 108 and a momentum wheel 109, respectively. The gimbal-a and gimbal-b are torque generating units equivalent to control moment gyroscopes. The dynamics of a satellite or like flying object are represented by a spacecraft dynamics 100 connected to the gimbals 107, 108 and momentum wheel 109.

As shown in FIG. 12, the gimbal-a 107, gimbal-b 108 and momentum wheel 109 are provided With rotors 111, 112 and 113, respectively. The angular momentum vectors of rotors 111, 112, 113 are represented by vectors <h₁₁₁>, <h₁₁₂> and <h₁₁₃>, respectively. Symbol “a” represents the angle of rotation of the gimbal-a 107 and the vector <\dot{a}> represents the gimbal rotation angular velocity vector of gimbal-a 107. Likewise, symbol “b” represents the angle of rotation of the gimbal-b 108 and the vector <\dot{b}> represents the gimbal rotation angular velocity vector of gimbal-b 108. Additionally, symbols \dot{a} and \dot{b} indicate the time derivatives of the rotation angles a and b, respectively.

In the discrete XYZ coordinate system of the satellite, the gimbal rotation axis of gimbal-a 107 runs parallel to the Y-axis of the satellite coordinate system and the angular momentum vector <h₁₁₁> of its rotor 111 is set parallel to the Z-axis in the initial state of the system. The gimbal rotation axis of gimbal-b 108 runs parallel to the X-axis and the angular momentum vector <h₁₁₂> of its rotor 112 is initially set parallel to the Z-axis. The angular momentum vector <h₁₁₃> of the rotor 113 of MW 109 runs parallel to the Z-axis. In this way, the prior art 3-axis attitude control system 100 comprises a single momentum wheel and two control moment gyroscopes.

When the attitude angle sensor 101 detects the attitude angle of the satellite and supplies its output to the attitude decision module 102, which estimates the attitude of the satellite from the input information and supplies the estimated result to the control module 103. Control module 103 produces control signals for application to the drivers 104, 105, 106 for controlling the gimbal-a 107, gimbal-b 108 and momentum wheel 109.

By rotating the rotor 111 of gimbal-a 107 about the gimbal axis, control torque vector <Tx> is generated about the X-axis. Likewise, the rotation of the rotor 112 of gimbal-b 108 about the gimbal axis causes control torque vector <Ty> to be generated about the Y-axis, and the rotation of the rotor 113 of momentum wheel 109 causes control torque vector <Tz> to be generated about the Z-axis. The vectors <Tx> and <Ty> are represented by Equations (1) and (2) below.

<Tₓ>=−<\dot{a}>×<h₁₁₁> (1)

<T_{y}>=−<\dot{b}>=<h₁₁₂> (2)

In this way, the satellite attitude is controlled by the torque generated by the gimbal-a 107, gimbal-b 108 and momentum wheel 109.

While the prior art attitude control system is capable of generating large control torque by the use of gimbal mechanisms for X- and Y-axis correction in comparison with the conventional momentum wheel that is used for Z-axis correction, the control resolution of angular velocity of the gimbals is constrained and hence precision attitude control is impossible.

Additionally, when the rotor 111 is given rotation about the gimbal axis to generate torque <Tx> about the X-axis, this rotation causes the angular momentum vector <h₁₁₁> to change its direction. Control torque <Tx> also changes its the direction according to Equation (1). As a result, it is difficult to continuously generate control torque about the X-axis. In a similar manner, when the rotor 112 is given rotation about the gimbal axis to generate torque <Ty> about the Y-axis, this rotation causes the angular momentum vector <h₁₁₂> to change its direction. Control torque <Ty> also changes its the direction according to Equation (2), making it difficult to continuously generate control torque about the Y-axis.

In order to solve the problems discussed above, the attitude control system of the present invention essentially comprises at least three reaction wheels whose rotation angles are mutually different from each other and at least two control moment gyroscopes whose gimbal axes are parallel to each other and whose rotors are given respective rotations in mutually opposite directions. The reaction wheels of the present invention provide high precision attitude correction and he control moment gyroscopes of the present invention provide high speed attitude correction.

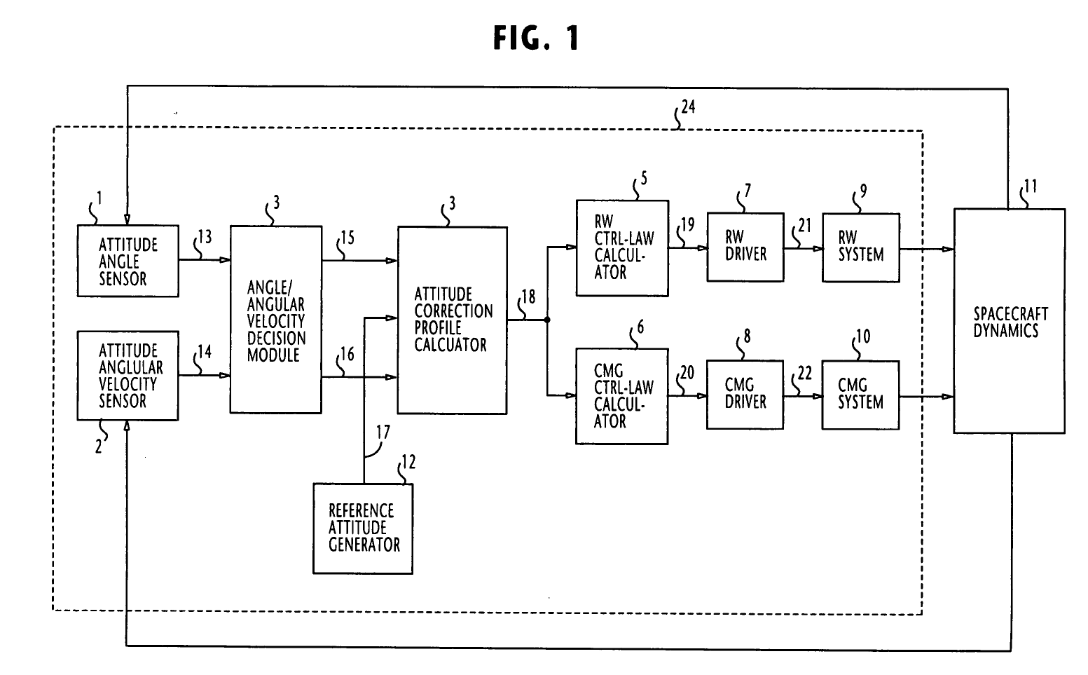

FIG. 1 is a block diagram of an attitude control system of a first embodiment of the present invention. The control signal 24 is connected to a spacecraft dynamics 11 and includes an attitude angle sensor 1, an attitude angular velocity sensor 2, an angle and angular velocity decision module 3 connected to both sensors 1 and 2, an attitude profile calculator 4, a RW (reaction wheel) control-law calculator 5, a CMG (control moment gyro) control-law calculator 6, a RW driver 7, a CMG driver 8, a RW system 9 and a CMG system 10. A reference (target) attitude generator 12 is connected to the attitude profile calculator 4.

Attitude angle sensor 1, such as star tracker, detects the attitude angle of the satellite and provides an attitude angle signal 13 to the decision module 3. Attitude angular velocity sensor 2, such as gyroscope (IRU), detects the angular velocity of the satellite and supplies an angular velocity signal 14 to the decision module 4. Based on the signals 13 and 14, the decision module 3 estimates the current attitude angle and current angular velocity of the satellite and produces an attitude angle signal 15 and an attitude angular velocity signal 16 and provides these signals to the profile calculator 4. According to the reference attitude of the satellite after its attitude is altered, the reference attitude generator 12 produces reference attitude angle telemetry data 17 and feeds the profile calculator 4.

By using a feedforward least-time control technique, the attitude control profile calculator 4 generates an attitude control profile to control the attitude of the satellite from the current to a reference profile in a short period of time and provides a attitude correction command 18 to the RW control-law calculator 5 and the CMG control-law calculator 6.

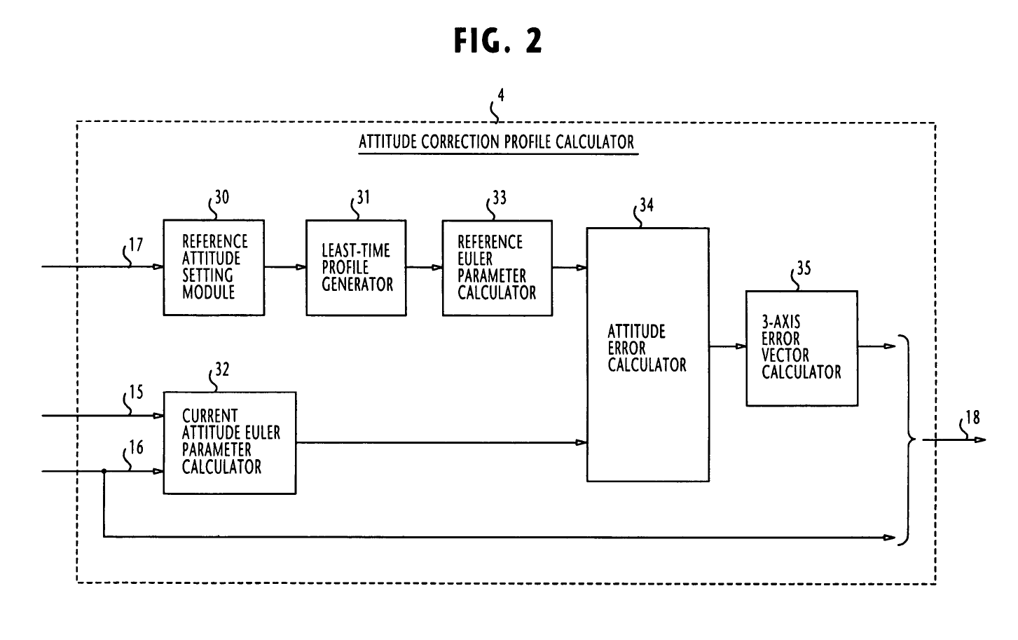

As shown in detail in FIG. 2, the profile calculator 4 includes a reference attitude setting module 30, a least-time profile generator 31, a current-attitude Euler parameter calculator 32, a reference Euler parameter calculator 33, an attitude calculator 34 and a 3-axis error vector calculator 35.

In the reference attitude setting module 30, the input telemetry data 17 is used in calculating the Euler axis vector <n> (i.e., attitude control rotation axis vector) and the attitude control angle θₘ about the attitude control rotation axis to determine the amount of time tₘ the satellite will take to correct its attitude and feed the least-time profile generator 31.

From the input data <n>, θₘ and tₘ, the least-time profile generator 31 derives an attitude control angular acceleration vector <αₘ> and feeds the reference Euler parameter calculator 33.

Reference Euler parameter calculator 33 performs a calculation on the input vector <αₘ> at sampling intervals to produce a reference Euler parameter vector <qᵣₒₜ> representing the reference attitude of the satellite and feeds the attitude error calculator 34.

Using the attitude angular velocity signal 16, the current-attitude Euler parameter calculator 32 updates the current Euler parameter vector <q> which represents the current attitude of the satellite. Attitude error calculator 34 calculates an error vector <qₑ> indicating the difference between the reference Euler parameter vector <qᵣₒₜ> and the current Euler parameter vector <q> and feeds the 3-axis attitude error vector calculator 35. The 3-axis attitude error vector calculator 35 derives 3-axis attitude error vector <θₑ> from the error vector <qₑ>. Note that the 3-axis attitude error vector <θₑ> indicates the rotation angle (Euler angle) about each coordinate axis of the satellite coordinate system.

Returning to FIG. 1, the RW control-law calculator 5 processes the attitude correction command 18 to generate a RW control signal 19 and feeds the RW driver 7. The CMG control-law calculator 6 processes the attitude correction command 18 to generate a CMG control signal 20 and feeds the CMG driver 8.

The RW driver 7 responds to the RW control signal 19 by producing a RW drive signal 21 and feeds the RW system 9. The CMG driver 8 responds to the CMG control signal 20 by producing a CMG drive signal 22 and feeds the CMG system 10.

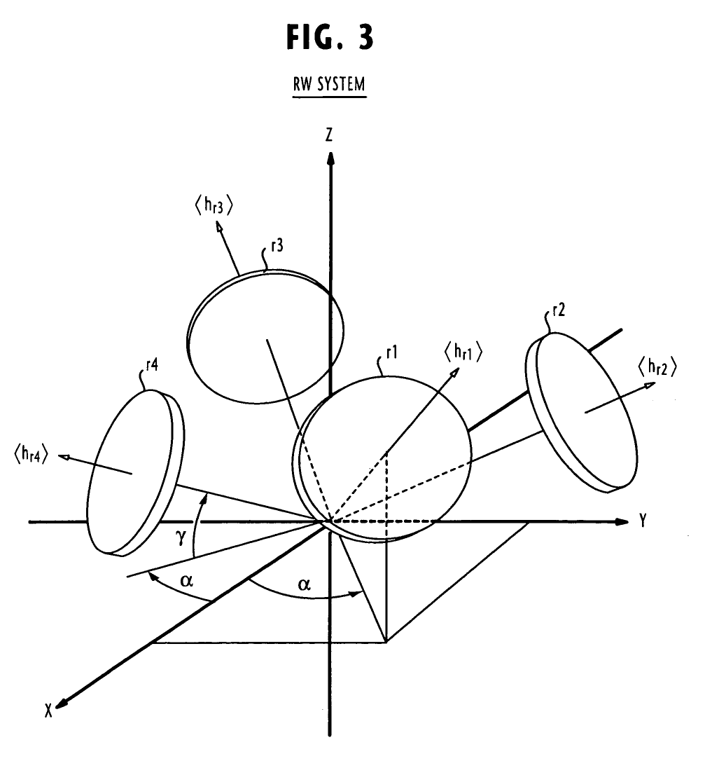

As shown in FIG. 3, the reaction wheel system 9 comprises a plurality of reaction wheels r1, r2, r3 and r4. On the satellite coordinate system (X, Y, Z axes), the angular momentum vectors <hᵣ₁>, <hᵣ₂>, <h_{r3> and <h}ᵣ₄> of the reaction wheels r1 to r4 are all skewed at the same angle γ relative to the X-Y plane in a positive direction along the Z axis. All reaction wheels r1, r2, r3, r4 are projected onto the first, second, third and fourth quadrants of the X-Y plane, respectively. The projected angular momentum vectors <hᵣ₁>, <hᵣ₂>, <hᵣ₃> and <hᵣ₄> on the X-Y plane are skewed at the same angle α relative to the X axis. By the rotation of the reaction wheels r1 to r4, control torque is produced for application to the spacecraft dynamics 11. At least three reaction wheels are necessary to implement the present invention.

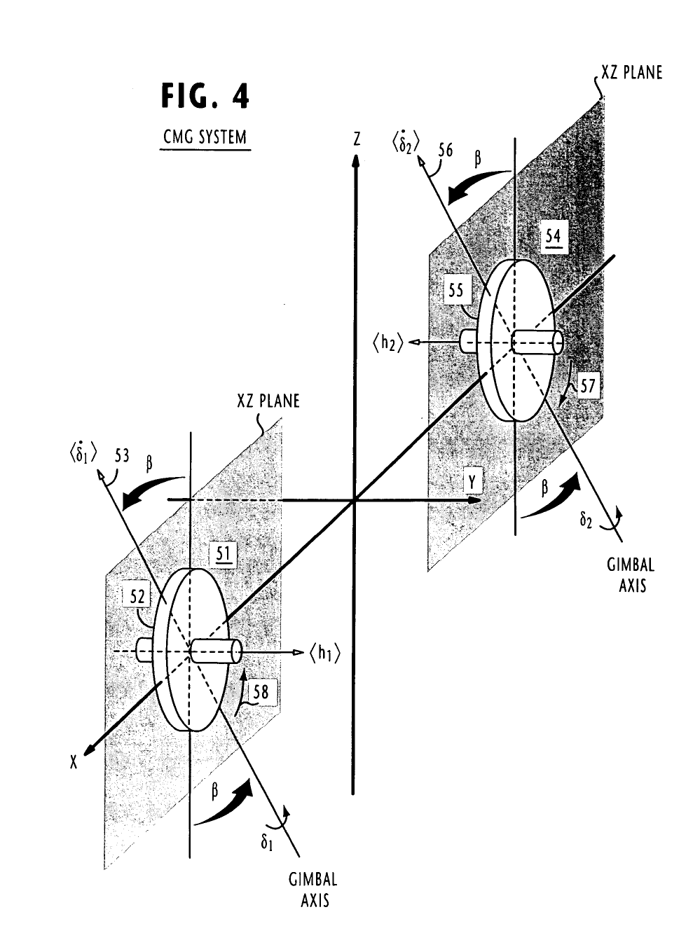

Details of the CMG system 10 are shown in FIG. 4. CMG system 10 comprises a pair of control moment gyroscopes 51 and 54. Rotors 52 and 55 are provided in the CMGs 51 and 54, respectively. These rotors 52, 55 are rotated in opposite directions to each other as indicated by arrows 57 and 58, respectively. CMG 51 has a gimbal axis 53 which lies on the X-Z plane of the satellite coordinate system. Gimbal axis 53 is skewed on the X-Z plane by fixed angle β relative to the Z axis about the spin axis of its rotor 52. The angle of the rotation about the gimbal axis 53 is designated δ₁. With this arrangement, the angular momentum vector <h₁> of rotor 52 always aligns itself in a direction normal to the direction of rotation of its gimbal. In a similar manner, the CMG 54 has a gimbal axis 56 lying on the X-Z plane. The gimbal axis 56 is skewed on the X-Z plane by fixed angle β relative to the Z axis about the spin axis of its rotor 55. The angle of rotation of the gimbal axis 56 is designated δ₂. With this arrangement, the angular momentum vector <h₂> of rotor 55 always orients itself in a direction normal to the direction of rotation of its gimbal. Note that in FIG. 4 the vectors <\dot{δ}₁> and <\dot{δ}₂> whose scaler values are the time derivatives of gimbal rotation angles δ₁ and δ₂ represent angular velocity vectors. By controlling the rotation of rotors 52 and 55 about the gimbal axes 53 and 56, the CMGs 51 and 54 generate control torque for the spacecraft dynamics 11.

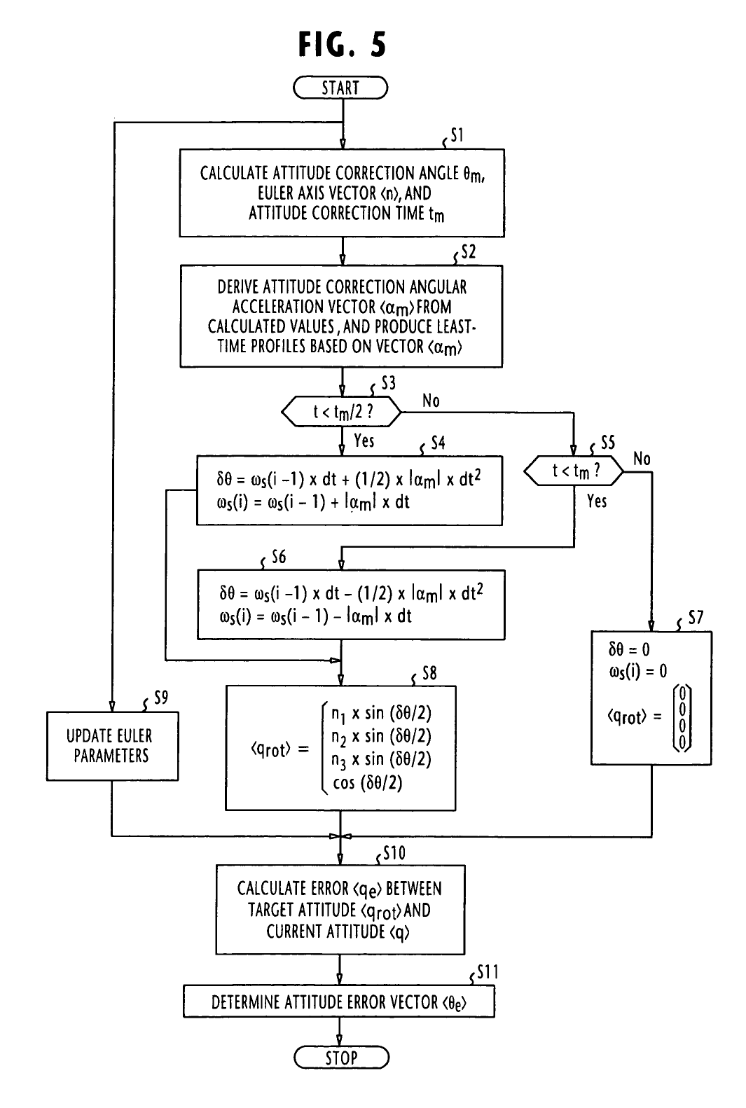

The operation of attitude profile calculator 4 of FIG. 2 is described in detail with reference to a flowchart shown in FIG. 5.

At step S1, the reference attitude setting module 30 receives reference attitude angle telemetry data 17 from the reference attitude generator 12. Based on this telemetry data, the reference attitude setting module 30 calculates an Euler axis vector <n> and attitude correction angle θₘ (which represents the attitude correction rotation axis vector) and establishes an attitude correction time interval tₘ as a reference and supplies the calculated values to the least-time profile generator 31.

At step S2, the least-time profile generator 31 derives an attitude correction angular acceleration vector <αₘ> from the input data as follows:

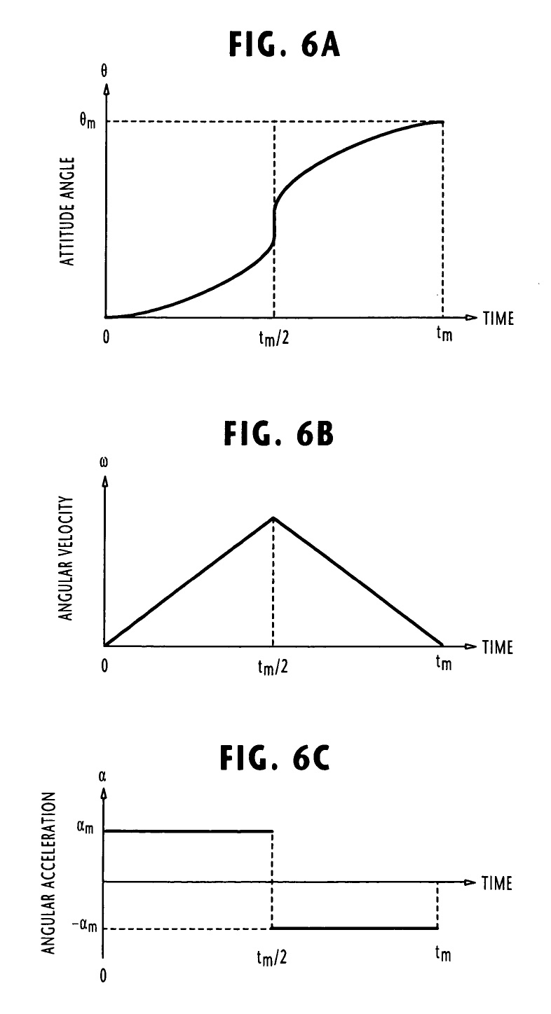

In order to efficiently process an attitude correction command within a given correction time tₘ, acceleration of constant positive value αₘ is applied to the satellite and then deceleration <−αₘ> of equal magnitude to that of acceleration but of negative polarity is applied to the satellite, as shown in FIG. 6C. In this case, the angular profile θₘ and angular velocity profile ω are generated as they would appear as shown in FIGS. 6A and 6B, respectively. If attitude correction angle θₘ and attitude correction time tₘ are given, attitude correction angular acceleration αₘ can be determined as follows:

$$α = \frac{4 \times {θ}_{m}}{{t}_{m}^{2}} \qquad ( 3 )$$

The direction of the attitude correction angular acceleration vector <αₘ> can be derived from Euler axis vector <n>. Based on the derived acceleration vector <αₘ>, the angle profile θₘ, angular velocity profile ω and angular acceleration profile αₘ are determined as shown in FIGS. 6A, 6B and 6C, respectively.

At decision step, the reference Euler parameter calculator 33 compares a time lapse “t” from the time instant attitude correction is started with the reference attitude correction time interval tₘ. If t<tₘ/2, flow proceeds from step S3 to step S4 to compute a differential correction angle δθ and a correction angular velocity ωₛ(i) according to Equations (4) and (5), respectively, by using the sampling time interval dt, the angular acceleration αₘ, and the previous correction angular velocity ωₛ(i-1).

$$δ θ = {ω}_{s} ( i - 1 ) \times dt + \frac{1}{2} \times \vert {α}_{m} \vert \times {dt}^{2} \qquad ( 4 )$$

ωₛ(i)=ωₛ(i-1)+|αₘ|×dt (5)

If step S3 determines that t≧tₘ/2, flow proceeds to step S5 to check to see if t<tₘ. If step S5 determines that t<tₘ, flow proceeds to step S6 to compute a differential correction angle δθ and a correction angular velocity ωₛ(i) according to Equations (6) and (7), respectively.

$$δ θ = {ω}_{s} ( i - 1 ) \times dt - \frac{1}{2} \times \vert {α}_{m} \vert \times {dt}^{2} \qquad ( 6 )$$

ωₛ(i)=ωₛ(i-1)−|αₘ|×dt (7)

If step S5 determines that t≧tₘ, flow proceeds to step S7 to set both δθ and ωₛ(i) to zero and set the Euler parameter vector (qᵣₒₜ) to a fixed value according to Equation (8), and flow proceeds to step S10.

$$⟨ {q}_{rot} ⟩ = [ \begin{matrix}0 \\ 0 \\ 0 \\ 1\end{matrix} ] ≡ {[ \begin{matrix}0 & 0 & 0 & 1\end{matrix} ]}^{T} \qquad ( 8 )$$

Following step S4 or S6, step S8 is executed for defining the Euler axis vector <n> as Equation (9), and calculating Euler parameter vectors <qᵣₒₜ> which indicate the reference attitudes for successive sampling intervals according to Equation (10). Following step S8, flow proceeds to step S10.

<n>=[n₁ n₂ n₃]^{T} (9)

$$\begin{matrix}⟨ {q}_{rot} ⟩ = {[ \begin{matrix}{q}_{rot1} & {q}_{rot2} & {q}_{rot3} & {q}_{rot4}\end{matrix} ]}^{T} \\ = {[ \begin{matrix}{n}_{1} sin \frac{δ θ}{2} & {n}_{2} sin \frac{δ θ}{2} & {n}_{3} sin \frac{δ θ}{2} & cos \frac{δ θ}{2}\end{matrix} ]}^{T}\end{matrix} \qquad ( 10 )$$

As steps S1 to S8 are executed, the Euler parameter calculator 32 updates the current attitude Euler parameter according to the input attitude angular velocity signal 16 as follows.

In the satellite's coordinate system, the angular velocities about the X, Y and Z axes are designated ω₁, ω₂ and ω₃, respectively. The angular velocity vector <ω> of the spacecraft dynamics 11 is given by Equation (11).

$$⟨ ω ⟩ = [ \begin{matrix}{ω}_{1} \\ {ω}_{2} \\ {ω}_{3}\end{matrix} ] = {[ \begin{matrix}{ω}_{1} & {ω}_{2} & {ω}_{3}\end{matrix} ]}^{T} \qquad ( 11 )$$

If the Euler axis vector <n> and the Euler parameter vector <q> are defined as Equations (12) and (13), respectively, the components of the Euler parameter vector <q> can be expressed as Equations (14), (15), (16) and (17) and Equation (18) can be established as follows:

<n>=[e₁ e₂ e₃]^{T} (12)

<n>=[q₁ q₂ q₃ q₄]^{T} (12)

$$\begin{matrix}{q}_{1} = {e}_{1} \times sin \frac{θ}{2} & ( 14 ) \\ {q}_{2} = {e}_{2} \times sin \frac{θ}{2} & ( 15 ) \\ {q}_{3} = {e}_{3} \times sin \frac{θ}{2} & ( 16 ) \\ {q}_{4} = cos \frac{θ}{2} & ( 17 )\end{matrix}$$

q₁²+q₂²+q₃²+q₄²=1 (18)

The derivative of the Euler parameter vector <q> is given by Equation (19), whose approximated discrete form is given by Equation (20). Using Equation (20), the Euler parameter vector <q> is updated.

$$\begin{matrix}⟨ \dot{q} ⟩ = \frac{1}{2} [ \begin{matrix}0 & {ω}_{3} & - {ω}_{2} & {ω}_{1} \\ - {ω}_{3} & 0 & {ω}_{1} & {ω}_{2} \\ {ω}_{2} & - {ω}_{1} & 0 & {ω}_{3} \\ - {ω}_{1} & - {ω}_{2} & - {ω}_{3} & 0\end{matrix} ] [ \begin{matrix}{q}_{1} \\ {q}_{2} \\ {q}_{3} \\ {q}_{4}\end{matrix} ] & ( 19 ) \\ q ( i ) = q ( i - 1 ) + \frac{1}{2} [ \begin{matrix}0 & {ω}_{3} ( i ) & - {ω}_{2} ( i ) & {ω}_{1} ( i ) \\ - {ω}_{3} ( i ) & 0 & {ω}_{1} ( i ) & {ω}_{2} ( i ) \\ {ω}_{2} ( i ) & - {ω}_{1} ( i ) & 0 & {ω}_{3} ( i ) \\ - {ω}_{1} ( i ) & - {ω}_{2} ( i ) & - {ω}_{3} ( i ) & 0\end{matrix} ] [ \begin{matrix}{q}_{1} ( i - 1 ) \\ {q}_{2} ( i - 1 ) \\ {q}_{3} ( i - 1 ) \\ {q}_{4} ( i - 1 )\end{matrix} ] Δ T & ( 20 )\end{matrix}$$

At step S10, the attitude error calculator 34, FIG. 2, produces an Euler parameter error vector <qₑ> by calculating the difference between the Euler parameter vector <qᵣₒₜ> obtained by steps S1 through S8 and the Euler parameter vector <q> obtained by step S9 according to Equation (21) given below.

$$⟨ {q}_{e} ⟩ = [ \begin{matrix}{q}_{e1} \\ {q}_{e2} \\ {q}_{e3} \\ {q}_{e4}\end{matrix} ] = [ \begin{matrix}{q}_{4} & {q}_{3} & - {q}_{2} & {q}_{1} \\ - {q}_{3} & {q}_{4} & {q}_{1} & {q}_{2} \\ {q}_{2} & - {q}_{1} & {q}_{4} & {q}_{3} \\ - {q}_{1} & - {q}_{2} & - {q}_{3} & {q}_{4}\end{matrix} ] [ \begin{matrix}{q}_{rot1} \\ {q}_{rot2} \\ {q}_{rot3} \\ {q}_{rot4}\end{matrix} ] \qquad ( 21 )$$

At step S11, the 3-axis error vector calculator 35 derives a 3-axis attitude error vector <θₑ> from the Euler parameter error vector <qₑ>. Since the error vector <qₑ> is much smaller than the Euler parameter vector <q>, the error vector <θₑ> is approximated by Equation (22) as follows:

<θₑ>=[2qₑ₁ 2qₑ₂ 2qₑ₃]^{T} (22)

In the RW control-law calculator 5, FIG. 1, the error vector <θₑ> and the attitude angular velocity signal 16 are used in calculating the proportional (P), integral (I), different al (D) values of PID control logic to determine the amount of control torque necessary for the RW system 9 to generate. The determined control torque is supplied as a RW control signal 19 to the RW driver 7, which in turn generates a RW drive signal 21 to be supplied to the RW system 9.

Because of the provision of four reaction wheels as shown in FIG. 3, the angular momentum vector <h_{RW}> of the RW system 9 are given by the following Equation (23).

$$⟨ {h}_{RW} ⟩ = [ \begin{matrix}cos γ \times cos α & - cos γ \times cos α & - cos γ \times cos α & cos γ \times cos α \\ cos γ \times sin α & cos γ \times sin α & - cos γ \times sin α & - cos γ \times sin α \\ sin γ & sin γ & sin γ & sin γ\end{matrix} ] [ \begin{matrix}{h}_{r1} \\ {h}_{r2} \\ {h}_{r3} \\ {h}_{r4}\end{matrix} ] \qquad ( 23 )$$

As a result, the control torque generated by the RW system 9 is given by a time derivative of Equation 23 as indicated by Equation (24) below.

$$⟨ {\dot{h}}_{RW} ⟩ = [ \begin{matrix}cos γ \times cos α & - cos γ \times cos α & - cos γ \times cos α & cos γ \times cos α \\ cos γ \times sin α & cos γ \times sin α & - cos γ \times sin α & - cos γ \times sin α \\ sin γ & sin γ & sin γ & sin γ\end{matrix} ] [ \begin{matrix}{\dot{h}}_{r1} \\ {\dot{h}}_{r2} \\ {\dot{h}}_{r3} \\ {\dot{h}}_{r4}\end{matrix} ] \qquad ( 23 )$$

The three-axis satellite attitude is corrected by controlling the magnitudes of the angular momentum vectors <hᵣ₁>˜<hᵣ₄> of the reaction wheels r1˜r4.

In the CMG control-low calculator 6, on the other hand, the error vector <θₑ> and the attitude angular velocity signal 16 are used in calculating the proportional (P), integral (I), differential (D) values of PID control logic to determine the amount of control torque necessary for the CMG system 10 to generate. The determined control torque is supplied as a CMG control signal 20 to the CMG driver 8, which in turn generates a CMG drive signal 22 to be supplied to the CMG system 10.

The angular momentum vectors <h₅₁> and <h₅₄> of the CMGs 51 and 54 are respectively given by Equations (25) and (26).

$$\begin{matrix}⟨ {h}_{51} ⟩ = [ \begin{matrix}{h}_{1} \times cos {δ}_{1} \times cos β \\ {h}_{1} \times sin {δ}_{1} \\ {h}_{1} \times cos {δ}_{1} \times sin β\end{matrix} ] & ( 25 ) \\ ⟨ {h}_{54} ⟩ = [ \begin{matrix}{h}_{2} \times cos {δ}_{2} \times cos β \\ {h}_{2} \times sin {δ}_{2} \\ {h}_{2} \times cos {δ}_{2} \times sin β\end{matrix} ] & ( 26 )\end{matrix}$$

Therefore, the angular momentum vector <h_{CMG}> is given by the following relation:

$$⟨ {h}_{CMG} ⟩ = ⟨ {h}_{51} ⟩ + ⟨ {h}_{54} ⟩ = [ \begin{matrix}{h}_{1} \times cos {δ}_{1} \times cos β + {h}_{2} \times cos {δ}_{2} \times cos β \\ {h}_{1} \times sin {δ}_{1} + {h}_{2} \times sin {δ}_{2} \\ {h}_{1} \times cos {δ}_{1} \times sin β + {h}_{2} \times cos {δ}_{2} \times sin β\end{matrix} ] \qquad ( 27 )$$

The control torque vector generated by the CMG system 10 is represented by Equation (28) which is a time derivative of Equation (27).

$$⟨ {\dot{h}}_{CMG} ⟩ = [ \begin{matrix}- {h}_{1} \times sin {δ}_{1} \times cos β & - {h}_{2} \times sin {δ}_{2} \times cos β & cos {δ}_{1} + cos β & cos {δ}_{2} \times cos β \\ {h}_{1} \times cos {δ}_{1} & {h}_{2} \times cos {δ}_{2} & sin {δ}_{1} & sin {δ}_{2} \\ - {h}_{1} \times sin {δ}_{1} \times sin β & - {h}_{2} \times sin {δ}_{2} \times sin β & cos {δ}_{1} \times sin β & cos {δ}_{2} \times sin β\end{matrix} ] [ \begin{matrix}{\dot{δ}}_{1} \\ {\dot{δ}}_{2} \\ {\dot{h}}_{1} \\ {\dot{h}}_{2}\end{matrix} ] \qquad ( 28 )$$

The three-axis satellite attitude is corrected by controlling the gimbal angles δ₁ and δ₂ and angular momentum vectors h₁ and h₂ of the two control moment gyroscopes, FIG. 4.

In the early stage of an attitude correction operation, the direction of angular momentum vector <h₁> of the rotor 52 is taken as +Y and the direction of angular momentum vector <h₂> of the rotor 55 is taken as −Y and their magnitudes are equal to each other. Rotors 52 and 55 are given rotation about their gimbal axes 53 and 55 at equal angular velocity in an equal direction by a predetermined angle. At this moment, the control torque produced by the CMG 51 is cancelled by the torque generated by the CMG 54 and no torque is produced by the CMG system 10 as a whole. Then, the rotors 52 and 55 are given rotation about their gimbal axes 53 and 55 at equal angular velocity in opposite directions. In this way, it is the magnitude of control torque that is the only factor in causing the satellite attitude to be corrected. Therefore, the satellite attitude is corrected in a desired direction with continuously generated control torque.

Since the RW system 9 is able to generate torque in 3-axis directions, the satellite attitude can be controlled precisely in all of its three axes, and since the CMG system 10 is able to continuously generate torque in a desired fixed direction the satellite attitude can be controlled in all its 3-axis directions at high speed. Thus, high-speed, high precision attitude control can be achieved.

In addition, if one of the four reaction wheels should fail, the remaining three reaction wheels allow the system to continue its operation.

Note that if the CMG system 10 comprises three or more control moment gyroscopes, 3-axis control torque can be described in the same way as in the case of the two control moment gyroscopes. By increasing the number of control moment gyros to be provided in the CMG system 10, the amount of control torque can be increased. However, the CMG system accounts for a substantial mass of the satellite, the number of control moment gyros is determined by tradeoffs between the control torque required and the mass of the satellite allowed.

In addition, if the angle β of FIG. 4 is set to zero, and the gimbal axis is made parallel to the Z axis, the CMG system 10 can deliver control torque exclusively about the X and Y axes according to Equation (28). For a satellite that serves as a platform of an astronomical telescope, for example, where there is only one or two axes to be controlled, the angle β can be set equal to zero. Note that the attitude control system of the present invention can also be used for other than satellites such as rockets and aircraft.

While gas jet thrusters may be used instead of control moment gyroscopes, a CMG system is preferred because its linear control ensures high accuracy compared to the ON-OFF (nonlinear) control of the gas jet thrusters.

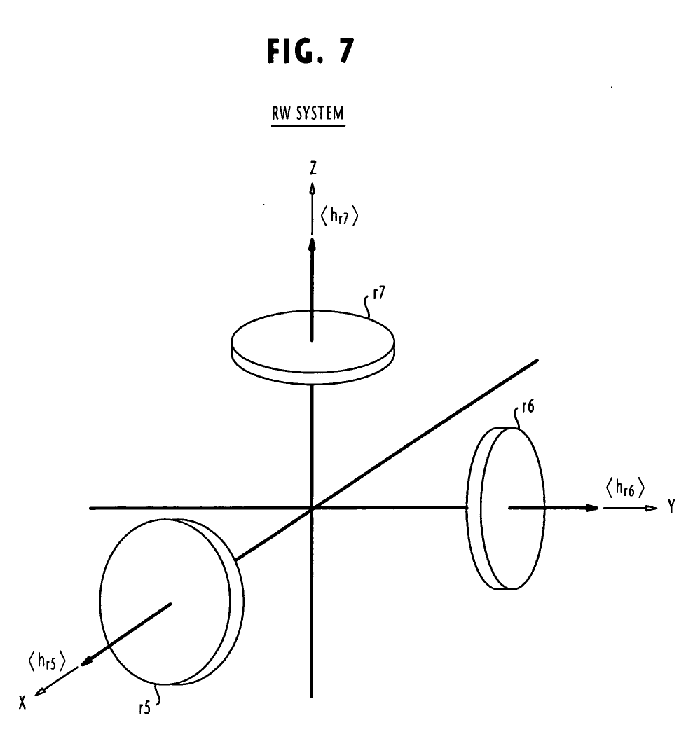

FIG. 7 is a perspective view of a modified form of the RW system 9. In this modified system, three reaction wheels r5, r6 and r7 are provided, which produce angular momentum vectors <hᵣ₅>, <h₆> and <h₇> whose directions are parallel to the X-, Y- and Z-axis, respectively. The RW system 9 generates control torque vector given as follows:

<\dot{h}_{RW}>=[\dot{h}ᵣ₅ hᵣ₆ hᵣ₇]^{T} (29)

As compared to the previous embodiment, the modified RW system gives a lightweight to the satellite. However, a failure of one reaction wheel cannot be backed up by other reaction wheels.

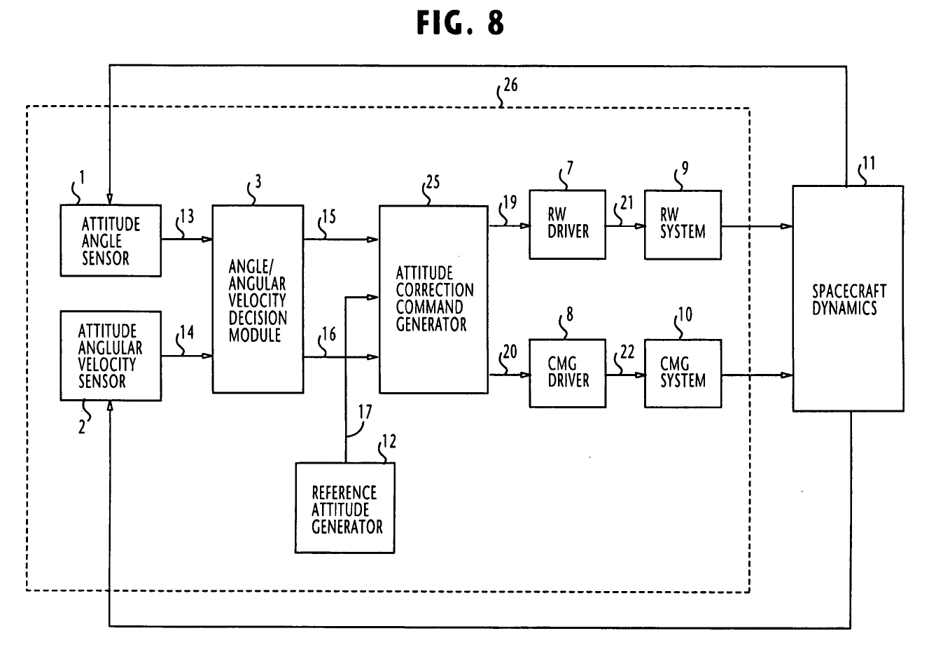

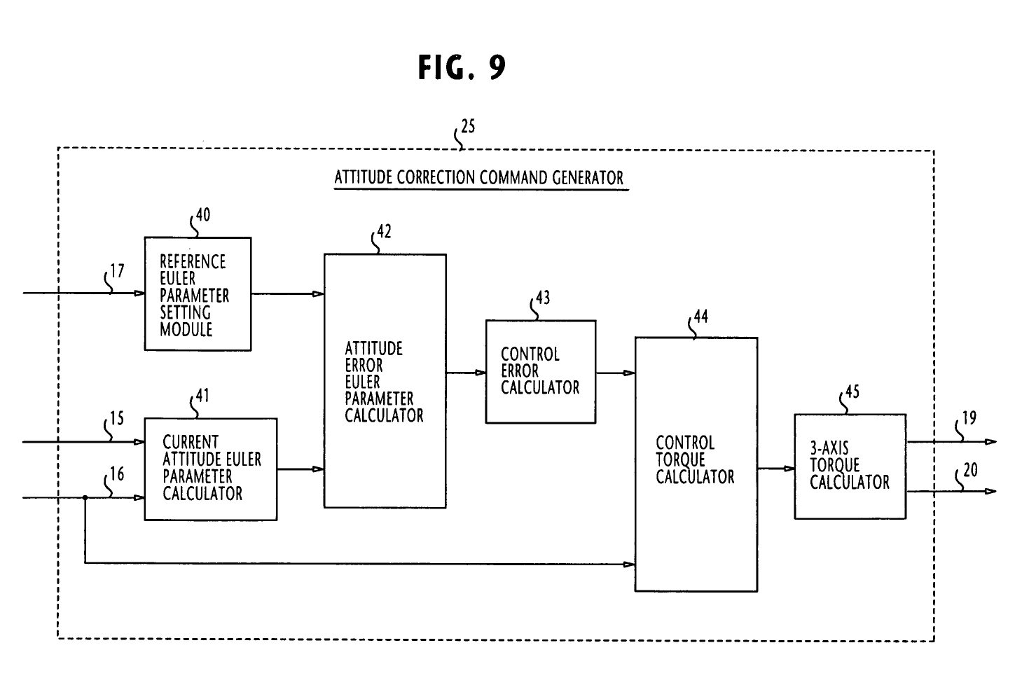

According to a second embodiment of the present invention, shown in FIG. 8, an attitude control 26 is provided. Attitude control system 26 differs from the attitude missing system 24 of FIG. 1 in that the calculators 4, 5 and 6 of FIG. 1 are replaced wit an attitude correction command generator 25. As shown in detail in FIG. 9, the attitude correction command generator 25 is comprised of a reference attitude Euler parameter setting module 40, a current attitude Euler parameter calculator 41, an attitude error Euler parameter calculator 42, a control error calculator 43, a control torque calculator 44 and a 3-axis control torque calculator 45.

In the reference attitude Euler parameter setting module 40, the reference attitude angle telemetry data 17 from the reference attitude generator 12 is used in calculating an attitude correction rotation axis vector (Euler vector) <n> by assuming that attitude correction involves only axis (Euler axis) and calculating an attitude correction angle θₘ about the Euler axis. Based on the calculated vector <n> and angle θₘ, an attitude correction time tₘ and a reference attitude Euler parameter vector <qᵣ> are established in the setting module 40 and supplied from the setting module 40 to the attitude error Euler parameter calculator 42.

In the attitude error Euler parameter calculator 42, an Euler parameter vector <qₑ> representing the attitude error is derived from the difference between the current attitude Euler parameter vector <q> and the reference attitude Euler parameter vector <qᵣ>. In the control error calculator 43, the Euler parameter vector <qₑ> is used in calculating a rotation axis vector <nₑ> which will be performed in the next sampling interval and an attitude error angle φₑ about this rotation axis. The calculated error angle φₑ is supplied to the control torque calculator 44, in which the error angle is used with the angular velocity signal 16 to determine the control torque τ for delivery to the 3-axis control torque calculator 45. Control torque τ is converted into three-dimensional vectors <τₑ>, which are supplied to the RW system 9 and CMG system 10.

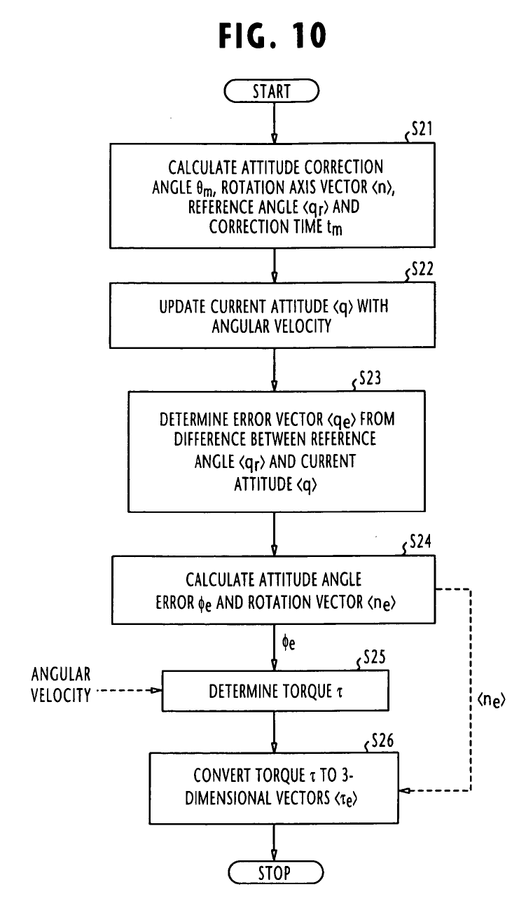

A flowchart shown in FIG. 10 illustrates the details of the attitude correction command generator 25. When the reference attitude Euler parameter setting module 40 receives the reference attitude angle telemetry data 17 (step S21), it calculates an attitude correction rotation axis vector (Euler vector) <n> by assuming that attitude correction involves only axis (Euler axis) and calculating an attitude correction angle θₘ about the Euler axis and establishes an attitude correction time tₘ and a reference attitude Euler parameter vector <qᵣ>. The reference attitude Euler parameter vector <qᵣ> is expressed by Equation (30).

<qᵣ>=[qᵣ₁ qᵣ₂ qᵣ₃ qᵣ₄]^{T} (30)

When the current attitude Euler parameter calculator 41 receives the attitude angle signal 15 and the attitude angular velocity signal 16 (step S22), Equation (11) representing the signal 16 is used in updating the current attitude Euler parameter vector <q> according to Equation (20). The updated vector is fed to the attitude error Euler parameter calculator 42.

At step S23, the attitude error Euler parameter calculator 42 derives an Euler parameter vector <qₑ> from the difference between the updated current attitude Euler parameter vector <q> and the reference attitude Euler parameter vector <qᵣ> according to Equation (31).

$$⟨ {q}_{e} ⟩ = [ \begin{matrix}{e}_{1} \\ {e}_{2} \\ {e}_{3} \\ {e}_{4}\end{matrix} ] = [ \begin{matrix}{q}_{4} & {q}_{3} & - {q}_{2} & - {q}_{1} \\ - {q}_{3} & {q}_{4} & {q}_{1} & - {q}_{2} \\ {q}_{2} & - {q}_{1} & {q}_{4} & - {q}_{3} \\ {q}_{1} & {q}_{2} & {q}_{3} & {q}_{4}\end{matrix} ] [ \begin{matrix}{q}_{r1} \\ {q}_{r2} \\ {q}_{r3} \\ {q}_{r4}\end{matrix} ] \qquad ( 31 )$$

In the control error calculator 43 (step 524), the attitude error Euler parameter vector <qₑ> is used in calculating the attitude error angle φₑ according to Equation (32) and the attitude correction rotation axis vector <nₑ> which will be performed in the next sampling interval according to Equation (33).

$$\begin{matrix}{φ}_{e} = 2 \times {tan}^{- 1} ( \sqrt{\frac{1 - {q}_{e4}^{2}}{{q}_{e4}}} ) & ( 32 ) \\ ⟨ {n}_{e} ⟩ = {[ \frac{{q}_{e1}}{sin ( \frac{{φ}_{e}}{2} )} \frac{{q}_{e2}}{sin ( \frac{{φ}_{e}}{2} )} \frac{{q}_{e3}}{sin ( \frac{{φ}_{e}}{2} )} ]}^{T} & ( 33 )\end{matrix}$$

At step S25, the control torque calculator 44 processes the angle error φₑ and the angular velocity signal 16 to produce the necessary control torque τ according to the PID control logic.

At step S26, the 3-axis torque calculator 45 processes the attitude correction rotation axis vector <nₑ> produced by the control error calculator 43 according to Equation (34) given below so that the control torque τ produced by step S25 is converted to 3-dimensional torque vectors <τₑ>.

<τₑ>=τ<nₑ> (34)

Specifically, the attitude correction about the Euler axis is converted to the attitude correction about the three axes of the satellite coordinate system. The 3-axis torque calculator 45 derives RW and CMG drive signals 19 and 20 from the 3-dimensional torque vectors <τₑ> and supplies these signals to the RW driver 7 and CMG driver for driving the RW system 9 and CMG system 10, respectively.

In the previous embodiment, the attitude control is performed by a sum of small attitude correction angles by successively decomposing an attitude command signal into respective coordinates of the satellite coordinate system and supplying the same correction signals to the RW and CMG systems so that they corporate with each other. These systems are basically controlled in a feedforward mode.

In the second embodiment, the attitude control is performed by a single rotation about an Euler axis which can be arbitrarily established in a 3-dimensional space and determining a torque while successively comparing the rotation about the Euler axis with a reference attitude angle, and distributing the determined torque into two components for driving the RW and CMG systems. These systems are basically controlled in a feedback mode.

Since the first embodiment uses an approximation equation at each sampling point, there is a possibility that small errors accumulate. However, the RW and CMG systems are controlled with ease in comparison with the second embodiment. In other words, the first embodiment is disadvantageous as long as complex logic is concerned, but advantageous because of its ease with which the actuators are controlled. Although the second embodiment requires a process for distributing respective control torque to each of the 3-axis actuators, they are controlled by a straightforward control logic.

It is seen from the foregoing description, the present invention provides high precision three-axis attitude correction of a satellite or like flying object by using at least three reaction wheels and high speed attitude correction of the flying object by using at least two control moment gyroscopes.

What is claimed is:

1. A system for controlling the attitude of a flying object, comprising:
at least three reaction wheels having mutually different rotation axes;
means for controlling rotation of said reaction wheels for controlling the attitude of said flying object;
at least two control moment gyroscopes having gimbal axes which extend in an equal direction, said gyroscopes including respective rotors; and
means for controlling rotation of said rotors in opposite directions to each other for controlling the attitude of said flying object so that angular momentum vectors of said rotors are produced in respective directions normal to the directions of rotation of said rotors about the respective gimbal axes.

2. The system of claim 1, wherein the number of said reaction wheels is four.

3. The system of claim 1, further comprising:
means for sensing an attitude angle and attitude angular velocity of said flying object;
means for calculating values of torque to be given to said reaction wheels and said control moment gyroscopes based on the sensed angle and angular velocity; and
means for driving said reaction wheels and said control moment gyroscopes according to the calculated values of torque.

4. The system of claim 3, wherein said sensing means detects said angle and angular velocity at unit intervals,
wherein said calculating means comprises:
means for setting a correction angle about an attitude correction rotation axis and correction angles respectively about the axes of a 3-axis coordinate system of said flying object with respect to a reference attitude of the flying object and a correction time;
means for calculating angular acceleration based on said correction angles and said correction time and producing therefrom an attitude angle profile;
means for successively calculating a reference attitude Euler parameter based on said attitude angle profile for indicating a reference attitude of said flying object at said unit intervals;
means for calculating a current attitude Euler parameter based on said angular velocity detected at said unit intervals for indicating a current attitude of said flying object;
means for detecting an attitude error Euler parameter representing a difference between said current attitude Euler parameter and said reference attitude Euler parameter;
means for calculating, for each axis of said coordinate system, an attitude error vector representing a rotation angle about the axis based on said attitude error Euler parameter;
means for calculating torque based on said attitude error vector for each of said reaction wheels; and
means for calculating torque based on said attitude error vector for each of said control moment gyroscopes.

5. The system of claim 3, wherein said sensing means detects said angle and angular velocity at unit intervals,
wherein said calculating means comprises:
means for setting a correction angle about an attitude correction rotation axis of said flying object with respect to a reference attitude of the flying object, a correction time and a reference attitude Euler parameter;
means for calculating a current attitude Euler parameter based on said angular velocity detected at said unit intervals for indicating a current attitude of said flying object;
means for detecting an attitude error Euler parameter representing a difference between said current attitude Euler parameter and said reference attitude Euler parameter;
means for detecting an attitude error angle about said attitude correction rotation axis which will be corrected during a subsequent time interval based on said attitude error Euler parameter;
means for calculating torque based on said attitude error angle; and
means for converting the calculated torque to 3-axis vectors corresponding to the three axes of said coordinate system for application to said reaction wheels and said control moment gyroscopes.

6. The system of claim 1, 2, 3, 4 or 5, wherein said flying object is a satellite.

7. A method of controlling the attitude of a flying object, comprising:
producing torque by controlling rotation of at least three reaction wheels whose rotation axes are mutually different from each other, and controlling rotation of respective rotors of at least two control moment gyroscopes whose gimbal axes extend in an equal direction, said rotation being such that said rotors are rotated in opposite directions to each other so that angular momentum vectors of said rotors are produced in respective directions normal to the directions of rotation of said rotors about the respective gimbal axes.

8. The method of claim 7, wherein said torque is produced by the step of producing torque for said reaction wheels and the step of producing torque for said control moment gyroscopes.

9. The method of claim 7, wherein said torque is produced by the step of simultaneously producing torque for said reaction wheels and said control moment gyroscopes.

10. The method of claim 7, 8 or 9, further comprising the steps of:
sensing an attitude angle and attitude angular velocity of said flying object;
calculating values of torque to be given to said reaction wheels and said control moment gyroscopes based on the sensed angle and angular velocity; and
driving said reaction wheels and said control moment gyroscopes according to the calculated values of torque.

11. The method of claim 10, wherein the sensing step comprises detecting said angle and angular velocity at unit intervals,
wherein the calculating step comprises the steps of:
setting a correction angle about an attitude correction rotation axis and correction angles respectively about the axes of a 3-axis coordinate system of said flying object with respect to a reference attitude of the flying object and a correction time;
calculating angular acceleration based on said correction angles and said correction time and producing therefrom an attitude angle profile;
successively calculating a reference attitude Euler parameter based on said attitude angle profile for indicating a reference attitude of said flying object at said unit intervals;
calculating a current attitude Euler parameter based on said angular velocity detected at said unit intervals for indicating a current attitude of said flying object;
detecting an attitude error Euler parameter representing a difference between said current attitude Euler parameter and said reference attitude Euler parameter;
calculating, for each axis of said coordinate system, an attitude error vector representing a rotation angle about the axis based on said attitude error Euler parameter;
calculating torque based on said attitude error vector for each of said reaction wheels; and
calculating torque based on said attitude error vector for each of said control moment gyroscopes.

12. The method of claim 10, wherein the sensing step comprises detecting said angle and angular velocity at unit intervals,
wherein said calculating step comprises:
setting a correction angle about an attitude correction rotation axis of said flying object with respect to a reference attitude of the flying object, a correction time and a reference attitude Euler parameter;
calculating a current attitude Euler parameter based on said angular velocity detected at said unit intervals for indicating a current attitude of said flying object;
detecting an attitude error Euler parameter representing a difference between said current attitude Euler parameter and said reference attitude Euler parameter;
detecting an attitude error angle about said attitude correction rotation axis which will be corrected during a subsequent time interval based on said attitude error Euler parameter;
calculating torque based on said attitude error angle; and
converting the calculated torque to 3-axis vectors corresponding to the three axes of said coordinate system for application to said reaction wheels and said control moment gyroscopes.
